(19) United States
(12) Patent Application Publication
(10) Pub. No.: US 2002/0131574 A1
(43) Pub. Date: Sep. 19, 2002

(54) Interactive system for optimizing service economy

(76) Inventor: James H. Alleman, Boulder, CO (US)

Correspondence Address: John P. Sutton, 2421 Pierce Street, San Francisco, CA, 94115, US

(21) Appl. No.: 10/151,410

(22) Filed: May 20, 2002

Related U.S. Application Data
(63) Continuation-in-part of application No. 09/466,504, filed on Dec. 17, 1999.
Application No. 09/466,504 is a continuation-in-part of application No. 08/798,115, filed on Feb. 12, 1997, now Pat. No. 6,035,027.
Application No. 08/798,115 is a continuation of application No. 08/252,984, filed on Jun. 2, 1994, now Pat. No. 5,883,964.
Application No. 08/252,984 is a continuation of application No. 07/873,323, filed on Apr. 24, 1992, now abandoned.

(51) Int. Cl. H04M 3/42

(52) U.S. Cl. 379/210.01

(57) ABSTRACT

A central location of a telephone switching system is placed where favorable local exchange tariffs are available. The central location includes a caller responsive unit which compares the caller identification accompanying the call attempt against a prestored list of identification data assigned to authorized system users. The system then calls the originating caller telephone from the central location. The system allows the originating caller to input the number of the party to whom a connection is desired by the originator. The system establishes a connection with the called party and bridges communications between the called and calling parties at the central location. The system includes the capability of employing audio responses of various types to calling or called parties.

This is a continuation in part of application Ser. No. 09/466,504 which is a continuation in part of application Ser. No. 08/798,115, now U.S. Pat. No. 6,035,027, which is a continuation of application Ser. No. 08/252,984, now U.S. Pat. No. 5,883,964, which is a continuation of application Ser. No. 07/873,323, filed Apr. 24, 1992, abandoned.

### BACKGROUND OF THE INVENTION

The present invention relates to telecommunications network systems in general and, more particularly, to telephone systems wherein interconnections between calling and called parties are performed under control of data processing or computer equipment. The present invention is especially useful in conjunction with telephone interconnection systems which are intended for providing the most economical domestic and international telephone service to those who subscribe to the service by providing apparatus and methods in a system organized for quickly and efficiently employing the most advantageous domestic and international tariff rates to user originated traffic.

Tariff rates for originating traffic often vary greatly. There is a need, therefore, to provide a service that will allow callers to take advantage of tariff rate difference to achieve the most economically advantageous cost for their respective domestic and international traffic. Another example is in the mobile telephone context, where the arbitrage may be between Calling Party Pays (CPP) and Receiving Party Pays (RPP) services.

### SUMMARY OF THE INVENTION

This invention, in cooperation with a public telephone network, mobile, data, or other networks, provides an automated call processing system that incorporates an audio response unit and computer in a system arrangement for enabling a subscriber to initiate calls whose network identified point-of-origin is a physical site other than the physical location of the subscriber. This objective will, among other things, enable subscribers to effectively realize the most economically advantageous use of differences between tariff rates.

Further, this invention enables subscribers to initiate calls through the public telephone network or other networks without concern of unauthorized disclosure of the network identification signal assigned to that subscriber. This invention also makes it possible to collect, store and archive detailed information of calls originated by subscribers for the purpose of billing subscribers and assisting with subscriber call management.

The objectives and advantages of this invention are achieved by providing subscribers with one, or more, signals that are assigned to this service by the service provider. When a subscriber uses an assigned signal to establish a call to this service, the system will identify the subscriber by using a computer and switch software program.

The service provider seizes an outbound path over which it outpulses a number the subscriber has previously had entered into the system subscriber list database as that subscriber's “call-back” number. The subscriber answers the system call-back and is prompted to input the number of the party the subscriber wishes to call (hereinafter referred to as “called party number”).

Following input of the called party number, the system seizes a second outbound path, outpulses the called party number over the second outbound path and bridges the subscriber onto the second line. After the called party answers, the system continues to monitor the connection for a signal that the subscriber wishes to either terminate the session, or establish another connection to another called party.

Accordingly, the present invention includes a method of providing economical telephone service by employing the most advantageous tariff between an originator and a called party. A central location service center is established at which a call-back number is provided for each subscribing call originator. A signal is assigned for use for all calls that are placed by that originator. This assigned signal is used to call the service center whereupon the originator is identified by the service center.

A signal is sent from the service center to the originator, thus indicating that the originator is identified. The service provider seizes a first outbound path over which the service center outputs the call-back number for the identified originator. This operation reconnects the service center to the originator.

The originator is prompted to input the telephone number of the called party the originator intends to call. A second outbound path is seized at the service center whereupon the called party number is outpulsed to this second outbound path. Finally, the originator is bridged to the second outbound path thus connecting the originator with the called party. The process, or system apparatus, in accordance with this invention, is preferably contained at a central location or service center. Since it is essentially self-contained for its purpose and requires a minimal number of lines connecting it to an exchange, the present invention is adaptable for relatively easy relocation to interface with the most economic tariff rate location wherever that might physically present itself throughout the world.

The process and apparatus of this invention interactively establishes communication links between a calling party and one or more parties called by that calling party. It employs input and output connections to an exchange that provides interface switching of the calling party with the central location. A signal is generated containing data uniquely identifying the originating station of the calling party which signal is placed on the input connection to the central location whenever the calling party places a call to that input connection from their station.

The central location stores the unique identifying data of one or more authorized calling party subscribers. A signal to the central station input connection attempting to establish communications causes the system to compare the data of the identifying signal associated with the connection attempt with the contents in the data storage.

In response to a favorable comparison, a call is originated from this central location to the calling party station. Signals are received from the calling party station for identifying a called party station with which the calling party desires to establish a communication connection. That is, these calling party originated signals identify a called party station. The central location finally bridges a communication connection between the calling party station and the called party station.

The signal from the subscriber to the central location serves to identify the subscriber and allow the service provider at the central location to ascertain the call-back number for the subscriber. These two functions can be accomplished by any inexpensive signal to the computer at the central location. Numerous systems known to those skilled in the art provide means for rapid transmission of telecommunications signals. A preferred system is the well-established use of Direct Inward Dial (DID) numbers through the Public Switched Telephone Network (PSTN). Packet switched network signals are highly satisfactory, using Transmission Control Protocols/Internet Program (TCP/IP, commonly known as Internet Protocol), X.25, X.400 or Frame Relay. Other systems include Very Small Aperture Terminal (VSAT) and Cable TV Networks. All of these alternatives to DID are defined in Newton's Telecom Dictionary (4^{th} Ed. 1991).

A network identification number, commonly known as an Automatic Number Identification (ANI) and/or Calling Number Identification (CNI), is widely employed in the telephone industry. Such numbers are required by the telephone network to rate, route, and bill appropriate parties for completed telephone calls. Current technologies in the public telephone network make it possible to disclose the calling party identification to the called party during the ringing cycle of the called party telephone. The present invention advantageously utilizes (but does not require) disclosure of this identification to the called party. Any system for transmitting a signal to the service provider to identify the subscriber, look up the call-back number and initiate the call-back process may be used.

The present invention is particularly well suited for advantageously utilizing the calling party identifying data in the form of the contemporary direct inward dial number produced by the exchange. Thus, the central location stores in a memory the direct inward dial number for each calling party authorized to utilize the system. Following a favorable comparison of the calling party number with a stored number, the system obtains the call-back number from storage for placing that number on an output connection to the exchange.

A failure of the called party to answer the call attempt from the central location can result in provision of an indication to the calling party that they can select between terminating connection attempts or attempting to establish a connection with another called party. The invention can accommodate establishment of a multiple party conference call in response to calling parties instructions to the central location.

The system is likewise well suited for receiving and collecting management and billing information on calls established by the system. This enables a determination of the extent of use of the system by authorized and/or unauthorized calling parties. After establishing a communication connection with the calling party station, the central location can respond to a special signal originated from the calling party station so as to terminate further communication and communication attempts with the calling party station. This invention can utilize a dual tone multi-frequency (DTMF) signal as the above-mentioned special signal from said calling party station.

The method and apparatus of this invention provides an economical telephone service by employing the most advantageous tariff between an originator and one or more called parties. A service center is established at which a call-back number is provided for each originator, and at which a signal is assigned for use for all calls that are placed by that originator. The assigned signal is used to call the service center whereupon the originator is identified by the service center.

A signal is sent from the service center to the originator thus indicating that the originator is identified. The service center then seizes a first outbound path over which the service center outputs the call-back number for the identified originator thereby reconnecting the service center to the originator.

The originator is prompted to input the telephone number of the called party the originator intends to call. A second outbound circuit is seized at the service center whereupon the called party number is outpulsed to the second outbound circuit. Bridging the originator to the second outbound circuit thus connects the originator with the called party.

Those having normal skill in the art will recognize the foregoing and other objects, features, advantages and applications of the present invention from the following more detailed description of the preferred embodiments as illustrated in the accompanying drawings.

### BRIEF DESCRIPTION OF THE DRAWINGS

FIG. 1 is a generalized block diagram of a system organization in accordance with the present invention.

FIG. 2 is a flow diagram of a component function of the system for determining the validity of a caller or subscriber attempt to signal into the system.

FIG. 3 is a flow diagram of a component function of the system responsive to either an invalid caller attempt to reach the system or failure of a valid user to terminate the call within a predetermined period of time.

FIG. 4 is a flow diagram of a component function of the system response in the presence of a valid input from a user or subscriber including an automated outdial attempt.

FIG. 5 is a flow diagram of a component function of a system attempt to establish a connection with a called party in response to a proper user input.

### DETAILED DESCRIPTION OF THE PREFERRED EMBODIMENT

A network identification number, commonly known as an Automatic Number Identification (ANI) and/or Calling Number Identification (CNI), are widely employed in the telephone industry. Such numbers are required by the public telephone network to rate, route and bill appropriate parties for completed telephone calls. Current technologies in the public telephone network makes it possible to disclose the calling party network identification numbers to the called party during the ringing cycle of the called party telephone. The present invention advantageously utilizes (but does not require) disclosure of these identification numbers to the called party.

The present invention advantageously utilizes the Direct Inward Dial (DID) numbers. Under local exchange company (LEC) tariffs it is possible to lease a block, or group, of telephone numbers. The size of the groups may vary between LECs, but a group of one hundred numbers is often a typical group. When these numbers are sequential, they are commonly referred to as blocks, but groups of random numbers are also used.

For purposes of this invention, sequential numbering is not required. The company leasing the numbers from an exchange does not have to lease a corresponding terminating circuit for each number in the group in order to place a call to each number. Instead, the company leases local facilities in quantities the company feels are adequate to handle traffic from the leased numbers. When a caller dials one of the numbers in the group, the central office of the terminating exchange (the exchange that assigned the numbers) will complete the call over any of the leased local facilities that are available and also pass the last four, sometimes five, numbers that the calling party dialed. The numbers that are passed are called the Direct Inward Dial, or DID, numbers.

If a calling party (in the case of this invention, a “subscriber”) is given one of the assigned numbers to dial to reach the system, the system can identify that subscriber because it will receive the last four, or five, numbers of the number the subscriber dialed. It is thereafter a relatively conventional software process to determine call validity by matching the DID numbers against a subscriber list.

Other signals beside DID numbers may be used to identify the subscriber and to ascertain the call-back number. Networks other than the public switched telephone network are suitable for requesting a call-back from the central location of the service provider. For example, packet switched networks are suitable to avoid tariffs of the public switched telephone network. X.25 is a fast, reliable and low-cost network for signaling the service provider to identify the subscriber and look up the call-back number. The Internet is also a fast, reliable and low-cost network for this purpose.

While a detailed illustrative description of a preferred embodiment of this invention is provided herein, those having normal skill in the art will recognize that there are a wide variety of physical communications systems, data formats and operating structures, available to implement this invention. Some of those alternatives may comprise structures and processes quite different from those of the disclosed description. Consequently, the specific structural and functional details disclosed herein are merely representative, yet in that regard they are deemed to afford the best description for purposes of disclosure of an enabling preferred embodiment and to provide a basis for understanding the spirit of this invention.

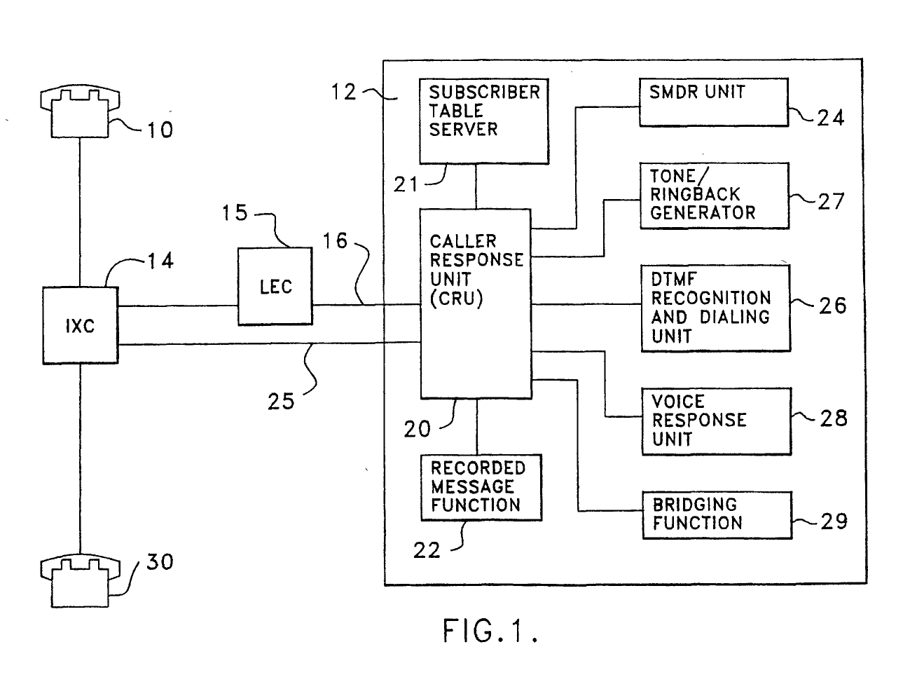

A block diagram of the system environment of this invention is presented in FIG. 1. A user or subscriber is represented as connected to the system via a telephone handset at station 10. The user initiates the system operation by sending a signal through the appropriate network, such as interexchange network (IXC) 14 using an appropriate signaling means, such as a DID number assigned to the service center master system 12 by local exchange company (LEC) 15. Alternatively, the path from user 10 to CRU 20 may be via the Internet, a packet switched network, a wireless network, or cable network or other telecommunications network.

LEC 15 directs the incoming signal via path 16 to a call response unit (CRU) 20. CRU 20 includes a computer, controller, or other suitable data processing unit along with appropriate sensing means as is conventional for data acquisition and control technology. CRU 20 will attempt to identify the caller by collecting the identifying signal from user 10, and deliver the signal to the subscriber table server 21, which contains the database that identifies subscribers by matching the identifying signal against a list of call-back numbers provided by subscribers.

More particularly, CRU 20 is a computer, or switch, that is connected to the LEC 15 central office and consisting of integrated components that permit the system to perform a number of functions integral to this invention. This includes switching functions to handle line (circuit) connections; interactive voice response operations; database controller for subscriber identification; and a system message detail recording (SMDR) unit 24 to provide information necessary to create call records.

Callers may also be identified via IXC 14 generated DTMF signals that are passed to the system. These are signaling tones used by customer premises equipment and LEC central offices to signal each other. A common use of DTMF by customer premises equipment is to pass to the central office the telephone number to which the calling party wishes to establish a connection.

If the caller reaches CRU 20 by calling an “800” number assigned to the system, CRU 20 will attempt to identify the caller by prompting the caller to enter, via DTMF, a personal identification number (PIN) unique to that subscriber. The PIN is then delivered to the subscriber table server 21 for comparison against the subscriber list of call-back numbers. It is important to note that, while the use of DID numbers is one of the most practicable means of obtaining subscriber recognition at this time, this invention is not limited to DID identification of subscribers.

As further technological services and features of the public network are introduced, particularly those services and features relying upon Signaling System 7 technology, this invention may achieve subscriber recognition through a variety of means, such as, but not limited to, calling number identification, automatic number identification and other technologies that permit recognition of the calling party as offered by LECs, wireless mobile carriers, cable television or satellite services, and other telecommunications carriers.

At the same time the CRU 20 delivers the DID digits to the subscriber table server 21, it also delivers call detail information to the system message detail recording database (SMDR) 24. The call detail information includes information relative to all events relating to the setup and completion of telephone calls to and from this invention.

CRU 20 responds to the incoming call signal by generating either a traditional ring-back signal, or a nonstandard sound (music, or some tone other than the normal ring-back signal). As a condition of the service, upon hearing the ring-back or nonstandard tone, the subscriber hangs up (goes on-hook).

When the subscriber table server 21 matches the DID digits with a subscriber call-back number, CRU 20 seizes one of the outbound circuits 25 from the group of such circuits that are connected directly to an IXC 14. The call-back number is then outpulsed by the DTMF recognition and dialing unit (hereinafter referred to as the DTMF generator) 26. When the subscriber answers (goes off-hook), CRU 20 activates voice responder unit 28 which prompts the subscriber to enter, via DTMF, a called party number. Automatic dialers do not use voice responder unit 28.

When the subscriber enters a called party number, CRU 20 seizes a second outbound circuit 25. DTMF Generator 26 recognizes the called party number DTMF digits entered by the subscriber and outpulses those digits over the second seized circuit. DTMF generator 26 activates bridging function 29 to bridge the subscriber onto the second outbound circuit. DTMF recognition and dialing unit 26 also monitors call progress tones; e.g., ringing, busy, off-hook (answer).

At all times, including after the called party has answered, CRU 20 continues to monitor the seized circuits 25 for a prearranged DTMF sequence that the DTMF Generator 26 will recognize as a signal from the subscriber indicating an intention to terminate the call in progress and possibly to initiate another call. Upon receiving the prearranged DTMF sequence, CRU 20 disconnects from the outbound circuit 25 connecting the called party to the system. The voice response unit 28, or some other audio signal, prompts the subscriber to input another called party number.

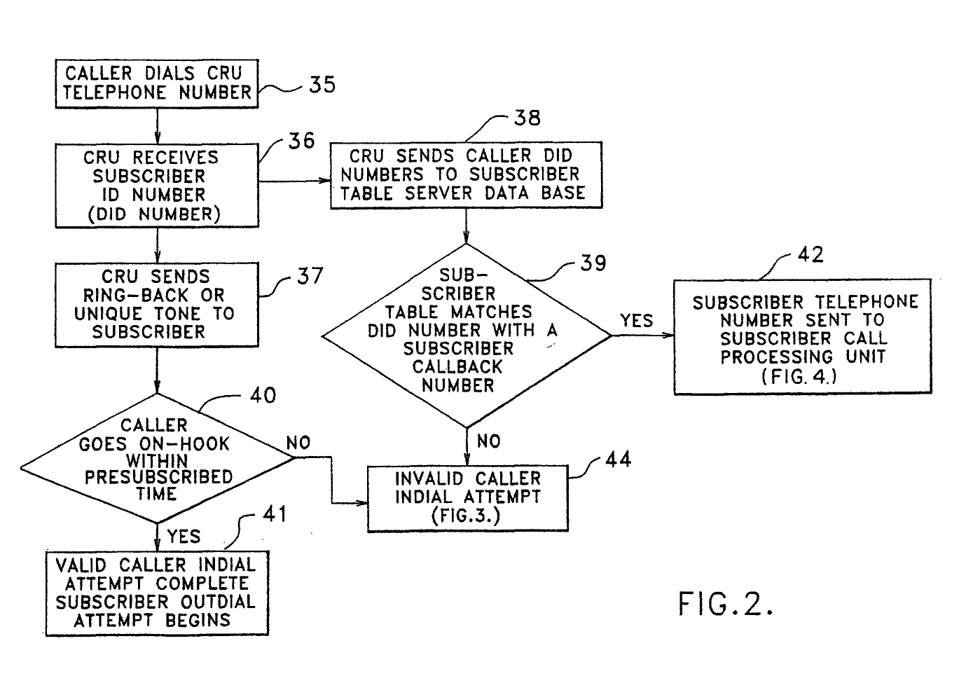

In the illustrative system example of FIG. 1, a series of operating processes are executed, as illustrated in the general flow diagrams of FIGS. 2 through 4, as described in detail below.

FIG. 2 illustrates the operating process using DID numbers as one embodiment of a signaling system a caller may use. This process is initiated at 35 when a caller dials one of the telephone numbers assigned to the system 12. CRU 20 receives the incoming call signal at 36 and the DID numbers at input 16 from the LEC 15, and responds at 37 with either a traditional ring-back signal, or nonstandard sound. By not going off-hook, the terminating central office for LEC 15 will not return answer supervision to the originating end of the circuit. Answer supervision is a signaling process by which the terminating LEC central office signals to the originating LEC central office that the called number has gone off-hook (answered) and timing should commence for billing purposes.

At the same time, CRU 20 delivers the DID numbers to the subscriber table server 21 at 38, which is followed by an attempt at 39 to match the DID digits with a subscriber call-back number stored in the database of subscriber table server 21. A favorable match results at 42 in the sending of the subscriber telephone number to the subscriber call processing unit (not shown). Upon hearing the ring-back, or nonstandard tone, caller 10 terminates the call to CRU 20 by hanging up (go on-hook) within a predetermined time at 40.

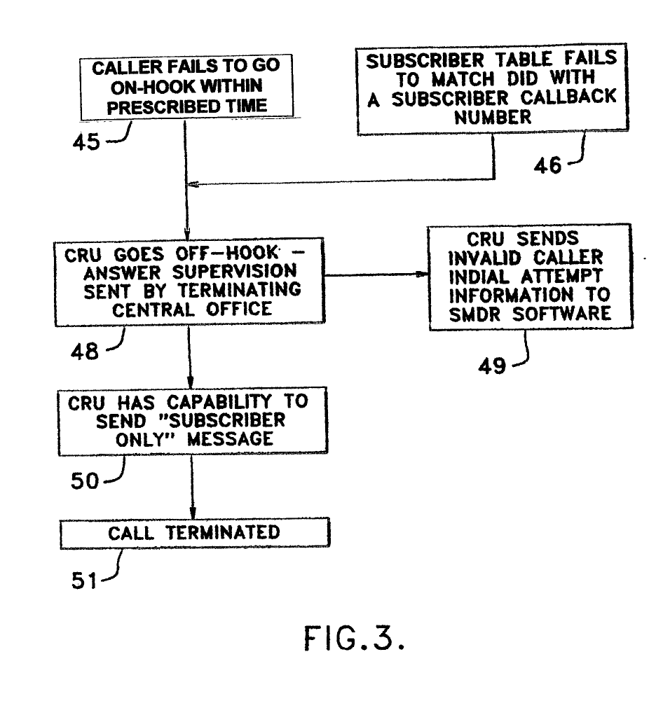

When the caller hangs up concurrent with a valid DID match 39, the valid call attempt is completed at 41. Note that the invalid call procedure of FIG. 3 is invoked at 44 if either a match of a valid DID number stored in the server 21 database is not produced or a failure is detected at 40 that the caller 10 has not terminated the call within a predetermined time period. The time period for subscribers to terminate the connection to CRU 20 upon hearing the ring-back, or unique tone, is predetermined. Typically suitable such time periods considered acceptable for this invention can vary between five and fifteen seconds.

FIG. 3 illustrates the process in response to failure conditions in the DID signaling system. Variants can be used for alternate signaling systems. The first response at 45 is to the fact that calling party 10 is off-hook or failed to hang up (go on-hook) within a predetermined time. This is treated as initiation of an invalid call attempt. When the predetermined time for calling party 10 to hang up elapses without a disconnect by caller 10, CRU 20 at 48 goes off-hook and sends answer supervision to the originating central office. When answer supervision is received at the originating central office, call completion takes place and timing of the call begins.

CRU 20 has the capability to send a voice message to the caller during an invalid caller indial attempt stating that service reached by the calling party is for subscribers only, as shown at 50. The message could also include a telephone number the calling party can call to initiate service if he, or she, desires. This message is sometimes hereinafter referred to as the “subscriber only message”. After delivering the message, CRU 20 terminates the call by going on-hook at 51.

FIG. 3 also illustrates at 46 the response to an invalid caller indial attempt indication that is created when the subscriber table server fails to match the DID digits received with a valid subscriber call-back number. CRU 20 indicates to the SMDR software at 49 that the invalid call attempt did occur.

Note that it is assumed for purposes of this invention that the failure of the calling party to terminate the call within the predetermined time limit means that the calling party is not a subscriber to the service provided by this invention. The call initiation into the central location 12 is thus deemed coincidental or perhaps even unauthorized.

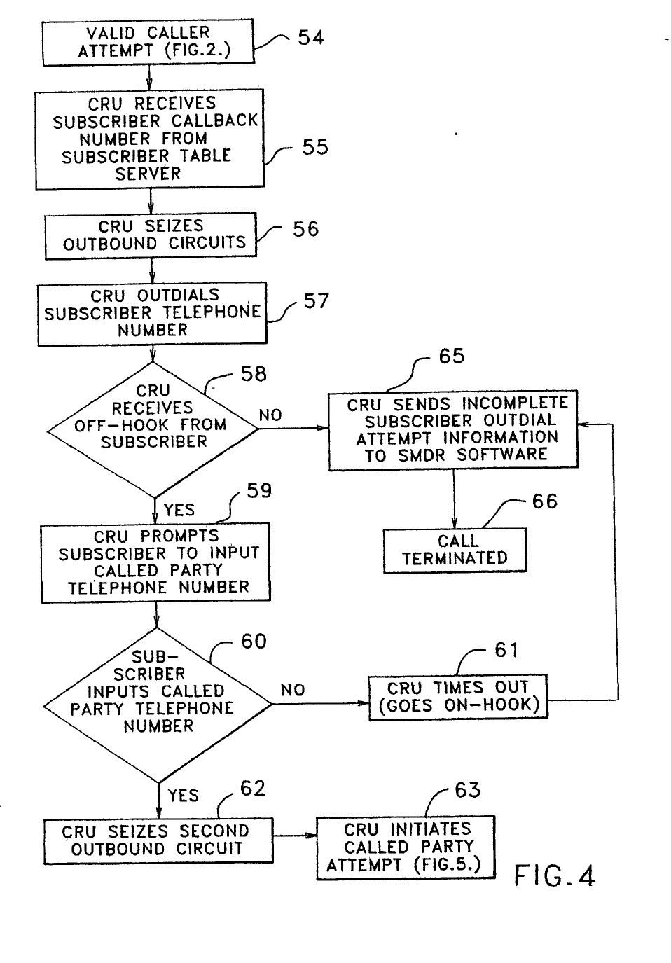

FIG. 4 illustrates the operating process in response to a subscriber call attempt. When the FIG. 2 process results in a decision that a valid subscriber identifying signal has occurred at 41, this initiates input 54 in FIG. 4. The subscriber table server (21) matches the subscriber identifying signal with a valid subscriber call-back number at 55. CRU 20 next seizes one outbound circuit 56, and calls the subscriber call-back number over the seized outbound circuit at 57.

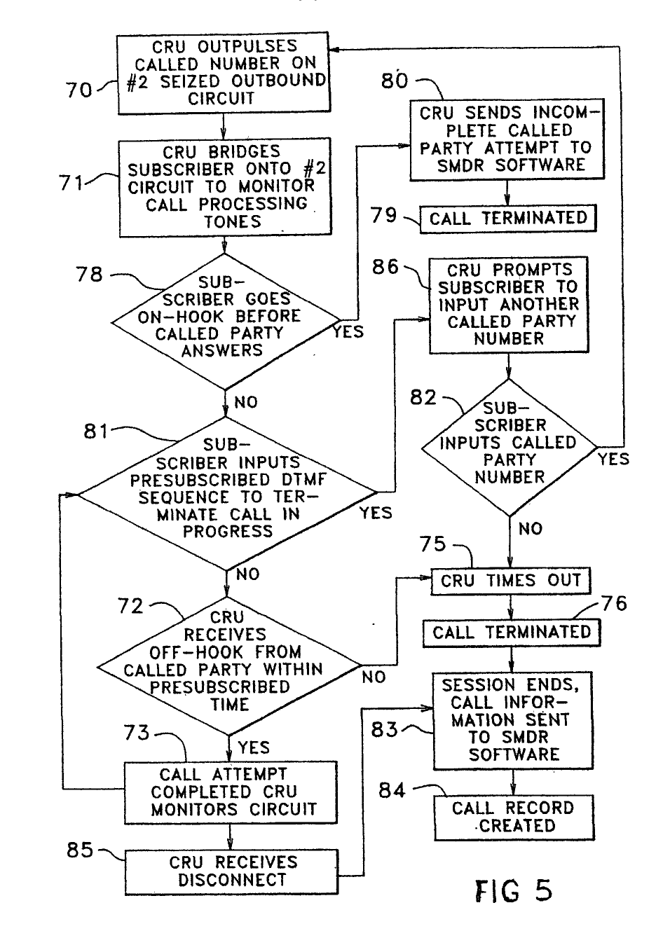

When the subscriber answers, CRU 20 will recognize the subscriber off-hook at 58, and prompt the subscriber at 59 to enter, via DTMF, a called party number. If decision 60 recognizes subscriber input of a called party number, CRU 20 seizes a second outbound circuit 62, and initiates a called party attempt 63. The steps associated with the called party attempt operating process are illustrated in FIG. 5, and described in detail below.

Decision 58 also recognizes whenever, after calling the subscriber call-back number, CRU 20 has not received an off-hook within a predetermined time. This results in CRU 20 terminating the call (66) and an incomplete subscriber call-back attempt is sent at 65 for recording in the SMDR database.

FIG. 5 illustrates the steps associated with a called party attempt operating process. When a second outbound circuit is seized, as described at 62 in FIG. 4, CRU 20 outpulses the called party number at 70, and bridges the subscriber onto the second outbound circuit to monitor call progress tones at 71. The called party answering or going off-hook within a predetermined time causes decision 72 to recognize that the called party attempt process is complete, and the CRU will continue to monitor the circuit 73.

Conversely, if CRU 20 decision 72 has not received an off-hook signal from the called party within a predetermined time 75, CRU 20 will time out and the call is terminated at 76. Also, if decision 78 notes that the subscriber terminated the connection by going on-hook (hanging up) before the called party answers, the called party attempt is terminated at 79, and an incomplete called party attempt is recorded in the SMDR data at 80.

Finally, if the subscriber inputs a prearranged DTMF sequence at 81, either prior to the called party answering or at anytime after the called party attempt is completed but before a disconnect signal is received, decision 81 terminates the called party attempt in progress, and CRU 20 will prompt the subscriber to input another called party number at 82. When decision block 82 recognizes presence of a subscriber input of another called party number, another called party attempt is initiated as CRU 20 outpulses the new called party number at 70.

A call is terminated 76, the call session ended 83 with call information sent to the SMDR software, and a call record created 84 under the following two conditions: First, if the CRU times out at 75, either because it does not receive a called party number within a predetermined time after prompting the subscriber to enter such a number 86, or because it does not receive an off-hook from a called party within a predetermined time 72; and second, if at any time CRU 20 receives a disconnect signal from either the subscriber or the called party end of the circuit 85.

The preferred embodiment may conveniently be carried out using alternative assigned signals to identify the subscriber and alternative paths to call back the subscriber and to call the called party. Thus, the signal to identify the subscriber and to request a call-back may conveniently be a signal over the Internet rather than a DID signal. Other alternative signals described above are suitable for identifying the subscriber and looking up the call-back number. Many others will occur to those skilled in the art without departing from the present invention.

The invention is not limited to use with the wireline public switched telephone network (PSTN). It can be used with wireless networks, cable networks, and packet switched networks. The outbound paths that are seized by the central location may be voice over internet protocol (VoIP), wireless, such as infrared or radio frequency, or any convenient alternative to land lines of the public switched telephone network.

While the exemplary preferred embodiment of the present invention are described herein with particularity, those having normal skill in the art will recognize various changes, modifications, additions and applications other than those specifically mentioned herein without departing from the spirit of this invention.

What is claimed is:

1. A system for establishing a communication link between a subscriber station and a destination station, both being connected through a network comprising:
control means operable for managing a database of caller information; storage means connected to the control means and operable for storing the database of caller information including a preassigned signal associated with a subscriber and a subscriber call-back number associated with the subscriber telephone station;
first connection means connected to the control means and operable for receiving an incoming signal as part of an incoming call attempt from the subscriber telephone station;
second connection means connected to the control means and operable for establishing a communication path;
the control means further operable for comparing the incoming signal to the preassigned signal and, if the incoming signal matches the preassigned signal associated with the subscriber, the control means is further operable for:
calling the subscriber through the outbound path;
receiving from the subscriber a calling number for the destination station;
calling the destination number through the second outbound path; and for bridging the path to the second path so that the subscriber is connected to the destination.

2. A system as in claim 1 wherein the preassigned signal associated with the subscriber is a means to (a) identify the subscriber and (b) to ascertain the stored subscriber call-back number.

3. A system as in claim 2 wherein the means to identify the subscriber and to ascertain the call-back number is a direct inward dial number.

4. A system as in claim 2 wherein the means to identify the subscriber and to ascertain the call-back number is a signal through a packet switched network.

5. A system as in claim 4 wherein the packet switched network is based on Internet Protocol.

6. A system as in claim 4 wherein the packet switched network is X.25.

7. A system as in claim 4 wherein the packet switched network is X.400.

8. A system as in claim 4 wherein the packet switched network is Frame Relay.

9. A system as in claim 2 wherein the means to identify the subscriber and to ascertain the call-back number is a signal via a cable television network.

10. A system as in claim 2 wherein the means to identify the subscriber and to ascertain the call-back number is an optical network.

11. A system as in claim 2 wherein the means to identify the subscriber and to ascertain the call-back number is a radio frequency network.

12. A method establishing a communication link between a subscriber and a destination comprising the steps of:
storing a preassigned signal associated with a subscriber;
storing a subscriber call-back number associated with the subscriber station;
receiving an incoming signal as part of an incoming call attempt from the subscriber telephone station;
comparing the incoming signal to the preassigned signal and if the incoming signal matches the preassigned signal associated with the subscriber, performing the following steps:
calling the subscriber on a first outbound path and connecting to the subscriber station;
receiving from the subscriber a calling number for the destination station;
calling the destination number through a second outbound path; and
bridging the first connection to the second connection so that the subscriber is connected to the destination.

13. A method as in claim 12 wherein the step of receiving the preassigned signal associated with the subscriber is via a direct inward dial number sent from the subscriber through the public switched telephone network.

14. A method as in claim 12 wherein the step of receiving the preassigned signal associated with the subscriber is via a packet switched network.

15. A method as in claim 13 wherein the packet switched network is X.25.

16. A method as in claim 13 wherein the packet switched network is X.400

17. A method as in claim 13 wherein the packet switched network is based on Internet Protocol.

18. A method as in claim 14 wherein the packet switched network is Frame Relay.

19. A method as in claim 12 wherein the step of receiving the preassigned signal associated with the subscriber is via an optional network.

20. A method as in claim 12 wherein the step of receiving the preassigned signal associated with the subscriber is via a cable TV network.

21. A method as in claim 12 wherein the step of receiving the preassigned signal associated with the subscriber is via a radio frequency network.
